(19) United States
(12) Patent Application Publication
(10) Pub. No.: US 2017/0194019 A1
(43) Pub. Date: Jul. 6, 2017

(54) SYSTEM FOR AUDIO ANALYSIS AND PERCEPTION ENHANCEMENT

(71) Applicants: Donald James DERRICK, Ilam, Christchurch (NZ); Tom Gerard DE RYBEL, Nieuwerkerken (BE)

(72) Inventors: Donald James DERRICK, Ilam, Christchurch (NZ); Tom Gerard DE RYBEL, Nieuwerkerken (BE)

(21) Appl. No.: 15/115,878

(22) PCT Filed: Feb. 13, 2015
(86) PCT No.: PCT/NZ2015/050014

§ 371 Date: Aug. 1, 2016

Related U.S. Application Data
(60) Provisional application No. 61/939,974, filed on Feb. 14, 2014.

(51) Int. Cl. G10L 21/06; G06F 3/01; G10L 21/0264; G10L 25/78; G10L 25/03

(52) U.S. Cl. CPC G10L 21/06; G10L 25/78; G10L 25/03; G10L 21/0264; G06F 3/016; G10L 2025/783

(57) ABSTRACT

An audio perception system is described, comprising a capture module configured to capture acoustic speech signal information; a feature extraction module configured to extract features that identify a candidate unvoiced portion in an acoustic signal; a classification module configured to identify if the acoustic signal is or contains an unvoiced portion based on the extracted features; and a control module configured to generate a control signal to a sensory stimulation actuator for generating an aero-tactile stimulation to be delivered to a listener, the control signal based at least in part on a signal representing the identified unvoiced portion. Related methods are also described.

### TECHNICAL FIELD

The present invention relates to a system for audio analysis and perception. Specifically, the present invention relates to a system for converting auditory speech information to aero-tactile stimulation, similar to air-flow that is produced in natural speech. The present invention further relates to a system for delivering that aero-tactile stimulation to a listener as the listener receives or hears the speech information to enhance perception of the speech information.

### BACKGROUND OF THE INVENTION

When people speak, they produce auditory, visual, and somatosensory (vibration and airflow) information that can potentially help a listener understand what he/she hears. While auditory information may be enough for speech perception, other streams of information can enhance speech perception. For instance, visual information from a speaker's face can enhance speech perception. Touching a speaker's face can also help speech perception. For example, techniques such as the Tadoma method, which is a method of communication enhancement where a person places their thumb on a speaker's lips and fingers generally along the speaker's jaw line, are used to help the hard-of-hearing understand speech.

Existing aero-tactile systems can enhance speech perception by applying air puffs, matching those produced from voiceless stops (which are a sub-set of the possible unvoiced utterances, and include consonants such as ‘p’, ‘t’, and ‘k’), to the hand, neck, or at distal skin locations (such as the ankle). The air puffs can be created by sending a 50 ms long signal opening a solenoid valve to release pressurized air (at about 5-8 psi) from a tube, to mimic a natural air puff produced from a speaker in the ‘p’ for ‘pa’ and the ‘t’ for ‘ta’.

A human operator manually identifies voiceless stops in a speech signal and determines the timing of a delivery of air puffs with the occurrence of voiceless stops in the speech. Once the voiceless stops in the signal have been identified, the audio signal can be delivered to the listener in combination with the air puffs.

As a result, existing aero-tactile systems are not suited for real-time applications. These systems require careful manual/human-assisted pre-processing of the auditory signal in order to align the air puff with the audio signal appropriately.

Other existing systems for enhancing speech perception include vibro-tactile devices. Aero-tactile stimulation is based upon the aperiodic components of speech, such that they are used to apply airflow-appropriate somatosensory stimulation. This can include air-flow itself, but could also be direct tactile or electro-tactile stimulation that mimics air-flow, or any other technique that allows the listener to use the signal. In contrast, vibro-tactile systems are based primarily upon the periodic (vibration) components of speech.

Vibro-tactile devices attach to various parts of the body and provide vibrations or vibro-tactile stimulation relating to the speech signal. Work relating to this technology is largely geared towards presenting a secondary source of the fundamental frequency and intonation patterns in speech, with some geared towards presenting vocalic (formant) information. This kind of information is produced from speech during times of low air-pressure from the lips, when little or no air-flow would have a chance of contacting the skin. Therefore, current vibro-tactile devices use precisely the information from the speech signal that an aero-tactile device does not, and vice-versa. In addition, vibro-tactile devices require training or prior awareness of the task to work.

It is an object of the present invention to provide a system for enhancing audio analysis and/or perception, and/or to at least provide the public with a useful choice.

### SUMMARY OF THE INVENTION

The present invention broadly consists of a system and method for audio perception enhancement by determining turbulent air-flow information from an acoustic speech signal, wherein an aero-tactile stimulation, which is configured to be delivered to a listener, is based at least in part on the determined turbulent air-flow information.

In one aspect the invention comprises an audio perception system, the system comprising a capture module configured to capture acoustic speech signal information; a feature extraction module configured to extract features that identify a candidate unvoiced portion in an acoustic signal; a classification module configured to identify if the acoustic signal is or contains an unvoiced portion based on the extracted features; and a control module configured to generate a control signal to a sensory stimulation actuator for generating an aero-tactile stimulation to be delivered to a listener, the control signal based at least in part on a signal representing the identified unvoiced portion.

The term ‘comprising’ as used in this specification means ‘consisting at least in part of’. When interpreting each statement in this specification that includes the term ‘comprising’, features other than that or those prefaced by the term may also be present. Related terms such as ‘comprise’ and ‘comprises’ are to be interpreted in the same manner.

Preferably the capture module is connected to a sensor configured to generate the acoustic speech signal information.

Preferably the sensor comprises an acoustic microphone.

Preferably the capture module is connected to a communication medium adapted to generate the acoustic speech signal information.

Preferably the capture module is connected to a computer-readable medium on which is stored the acoustic speech signal information.

Preferably the capture module comprises a pressure transducer.

Preferably the capture module comprises a force sensing device placed in or near the air-flow from the lips of a human speaker.

Preferably the capture module comprises an optical flow meter.

Preferably the capture module comprises a thermal flow meter.

Preferably the capture module comprises a mechanical flow meter.

Preferably the capture module is configured to capture acoustic speech signal information including information from turbulent flow and/or a speech pressure wave generating turbulent flow.

Preferably the feature extraction module is configured to identify salient aspects of the signal that, when interpreted by the classification module, are used to identify unvoiced portions based on one or more of the extracted features of the acoustic signal.

Preferably the feature extraction module is configured to extract features relevant to unvoiced portions based on one or more of a zero-crossing rate, a periodicity, an autocorrelation, an instantaneous frequency, a frequency energy, a statistical measure, a rate of change, an intensity root mean square value, time-spectral information, a filter bank, a demodulation scheme, or the acoustic signal itself.

Preferably the feature extraction module is configured to compute the zero-crossing rate of the acoustic signal, the classification module using said zero crossing rate to indicate that a portion of the acoustic signal is an unvoiced portion if at least one of zero-crossings per unit of time of the portion of the acoustic signal is above a threshold.

Preferably the feature extraction module is configured to compute a frequency energy of the acoustic signal, the classification module indicating that a portion of the acoustic signal is an unvoiced portion if the frequency energy of the portion of the acoustic signal is above a threshold.

Preferably the feature extraction module is configured to calculate the frequency energy based on Teager's energy.

Preferably the feature extraction module is configured to compute a zero-crossing and frequency energy of the acoustic signal that, when combined, is used by the classification module to identify if the acoustic signal is or contains the unvoiced portion.

Preferably the feature extraction module is configured to use a low frequency acoustic signal from a sensor to identify the candidate unvoiced portion in an acoustic signal.

Preferably the classification module is configured to identify the unvoiced portion based on one or more of heuristics, logic systems, mathematical analysis, statistical analysis, learning systems, gating operation, range limitation, and normalization on the candidate unvoiced portion.

Preferably the control module is configured to generate the control signal based on a signal representing the candidate unvoiced portion in the acoustic signal.

Preferably the control module is configured to convert the signal representing the unvoiced portion into a signal representing turbulent air-flow based on energy in the turbulent air-flow information of the unvoiced portion, transformed based upon the relationship between this energy and likely air-flow from speech.

Preferably the signal representing turbulent air-flow is an envelope of the acoustic signal representing turbulent air-flow information.

Preferably the signal is a differential of the signal representing the unvoiced portion.

Preferably the signal is an arbitrary signal having at least one signal characteristic, where the at least one signal characteristic indicates an occurrence of turbulent information in the acoustic signal.

Preferably the signal comprises an impulse train where a timing of each impulse indicates the occurrence of turbulent information.

Preferably the signal characteristic comprises one or more of a peak, a zero-crossing, and a trough.

Preferably the system further comprises at least one post-processing module.

Preferably the at least one post-processing module is configured to filter, use linear or non-linear mapping, use gating operations, use range limitations, and/or normalization to enhance a signal to the at least one post-processing module.

Preferably the at least one post-processing module is configured to filter the signal using one or more of high pass filtering, low pass filtering, band pass filtering, band stop filtering, moving averages and median filtering.

Preferably the at least one post-processing module comprises a post-feature extraction processing module for processing a signal representing the extracted features for the candidate unvoiced portion for the classification module, the classification module configured to identify the unvoiced portion based on an output from the post-feature extraction processing module.

Preferably the at least one post-processing module comprises a post-classification module for processing the signal representing the unvoiced portion from the classification module, the control module configured to generate the control signal based on an output from the post-classification processing module.

Preferably the at least one post-processing module comprises a post-control processing module for processing the control signal from the control unit, the sensory stimulation actuator configured to output an aero-tactile stimulation based on an output from the post-control processing module.

Preferably the at least one post-processing module comprises a post-control processing module for processing the control signal from the control unit.

Preferably the sensory stimulation actuator comprises an optical actuator that is configured to output an optical stimulation based on an output from the post-control processing module.

Preferably the optical actuator comprises a light source in an electronic device of the listener.

Preferably the optical stimulation comprises a change in brightness in a backlight display of the electronic device.

Preferably the sensory stimulation actuator comprises a somatosensory actuator that is configured to output a stimulation based on an output from the post-control processing module.

Preferably the sensory stimulation actuator comprises a sound actuator that is configured to output an audible stimulation based on an output from the post-control processing module.

Preferably the sound actuator comprises an acoustic sub-system of a host device, and/or a loud speaker.

Preferably the acoustic signal comprises a speech signal.

Preferably the acoustic signal comprises any information caused from turbulent vocal tract air-flow.

Preferably the acoustic signal comprises any information caused from artificial turbulent vocal tract air-flow.

Preferably the acoustic signal comprises speech, acoustic information, and/or audio produced by a speech synthesis system.

Preferably the system further comprises a receiver for receiving the acoustic signal.

Preferably the receiver is configured to receive the acoustic signal from a sensor device.

Preferably the sensor comprises an acoustic microphone device.

Preferably the microphone device comprises a microphone digitizer for converting the acoustic signal from a microphone to a digital signal.

Preferably the receiver is configured to receive the acoustic signal from an external acoustic source.

Preferably the receiver is configured to receive the acoustic signal in one of real-time or pre-recorded.

Preferably the system further comprises a post-receiver processing module for removing undesired background noise and undesired non-speech sound from the acoustic signal.

Preferably the capture module is configured to capture acoustic speech signal information from a pre-filtered speech acoustic signal.

Preferably the capture module is configured to capture acoustic speech signal information from clean acoustic signals not requiring filtering.

Preferably the system further comprises a sensory stimulation actuator for generating the aero-tactile stimulation.

Preferably the sensory stimulation actuator is configured to generate the aero-tactile stimulation based at least partly on the control signal directly from the control module and/or indirectly from the control module via a post-control processing module.

Preferably the sensory stimulation actuator is configured to generate the aero-tactile stimulation based at least partly on the unvoiced portion directly from the classification module and/or indirectly from the classification module via a post-classification processing module.

Preferably the sensory stimulation actuator comprises an aero-tactile actuator.

Preferably the aero-tactile stimulation comprises one or more air puffs and/or air-flow.

Preferably the sensory stimulation actuator comprises a vibro-tactile actuator.

Preferably the vibro-tactile actuator is configured to generate a vibro-tactile stimulation based on a voiced portion in the acoustic signal.

Preferably the aero-tactile stimulation comprises direct tactile stimulation for simulating somatosensory senses of the listener.

Preferably the sensory stimulation actuator comprises an electro-tactile actuator, the aero-tactile stimulation comprising an electrical stimulation for simulating somatosensory senses of a listener.

Preferably the sensory stimulation actuator comprises an optical actuator, the aero-tactile stimulation comprising optical stimuli.

Preferably the sensory stimulation actuator comprises an acoustic actuator, the aero-tactile stimulation comprising auditory stimuli.

Preferably the sensory stimulation actuator is configured to deliver the two or more different aero-tactile stimulations to the listener.

Preferably the two or more different aero-tactile stimulations comprise two or more of physical taps, vibration, electrostatic pulses, optical stimuli, auditory stimuli, and other sensory stimulation.

Preferably the aero-tactile stimulation(s) is/are generated using the acoustic signal, the features extracted from the acoustic signal by the feature extraction module, the identified unvoiced portion from the classification module, or derivatives of the signal representing the candidate and/or identified unvoiced portion, which contains the turbulent air-flow energy.

Preferably the identified unvoiced portion comprises the inverse of the turbulent air-flow signal.

Preferably the sensory stimulation actuator is configured to deliver the aero-tactile stimulation on to the listener's skin.

Preferably the sensory stimulation actuator is configured to deliver the stimulation to any tactile cell of the listener.

In another aspect the invention comprises a method for acoustic perception, the method comprising capturing, by a capture module, acoustic speech signal information; determining, by a feature extraction module, features that identify a candidate unvoiced portion in an acoustic signal; determining, by a classification module, if the acoustic signal is or contains an unvoiced portion based on the extracted features; and generating, by a control module, a control signal to an actuator for generating an aero-tactile stimulation to be delivered to a listener, the control signal based at least in part on a signal representing the unvoiced portion.

Preferably the method further comprises delivering, by a sensory stimulation actuator, the aero-tactile stimulation to a listener, wherein the aero-tactile stimulation is generated based on the stimuli from the actuator.

Preferably the sensory stimulation actuator comprises one or more actuators that is/are configured to deliver the aero-tactile stimulation information to the listener, in the form of tactile stimulation, optical/visual stimulation, auditory stimulation, and/or any other type of stimulation.

As used in this specification, ‘aero-tactile stimulation’ refers to sensory stimulation that is based on air-flow, such as turbulent air-flow portions in speech. The sensory stimulation is delivered to a somatosensory portion of the listener's body. This stimulation is generally based on the aperiodic components of speech. An actuator that provides aero-tactile stimulation can be configured to provide somatosensory stimulation based on the air-flow information. The stimulation may include air-flow itself. Additionally or alternatively, the stimulation could include direct tactile or electro-tactile stimulation that mimics air-flow, auditory stimuli, or any other technique that allows the listener to receive/sense the turbulent air-flow information.

Embodiments of the method are similar to the embodiments described with reference to the first aspect for the system above.

The invention accordingly comprises several steps and the relation of one or more of such steps with respect to each of the others, and the apparatus embodying features of construction, combinations of elements and arrangement of parts that are adapted to affect such steps, all is exemplified in the following detailed disclosure.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

In addition, where features or aspects of the invention are described in terms of Markush groups, those persons skilled in the art will appreciate that the invention is also thereby described in terms of any individual member or subgroup of members of the Markush group.

As used herein, ‘(s)’ following a noun means the plural and/or singular forms of the noun.

As used herein, the term ‘and/or’ means ‘and’ or ‘or’ or both.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9, and 10) and also any range of rational numbers within that range (for example, 2 to 8, 1.5 to 5.5, and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

Although the present invention is broadly as defined above, those persons skilled in the art will appreciate that the invention is not limited thereto and that the invention also includes embodiments of which the following description gives examples.

### BRIEF DESCRIPTION OF THE DRAWINGS

For a more complete understanding of the invention, reference is made, by way of non-limiting example, to the following description and accompanying drawings, in which:

FIG. 1 shows a block diagram of the system according to a first embodiment of the present invention;

FIG. 2 shows an auditory speech waveform with the intensity of turbulent air-flow;

FIG. 3 shows a block diagram of the system according to a second aspect of the present invention;

FIG. 4 shows a flow-chart of the software components of the zero-crossing method according to an embodiment of the present invention;

FIG. 5 shows a flow-chart of the software components of Teager's energy/DESA method combined with the zero-crossing method according to an embodiment of the present invention;

FIG. 6 shows example waveforms of the signal at different stages of the system shown in FIG. 5;

FIG. 7 shows the implementation of the system according to an embodiment of the present invention in a behind-the-ear hearing-aid;

FIGS. 8A and 8B shows the implementation of the system according to an embodiment of the present invention in a smart phone or smart device;

FIG. 9 shows the implementation of the system according to an embodiment of the present invention in headphones.

FIG. 10 shows the implementation of an aero-tactile actuator.

### DETAILED DESCRIPTION OF THE PREFERRED EMBODIMENTS

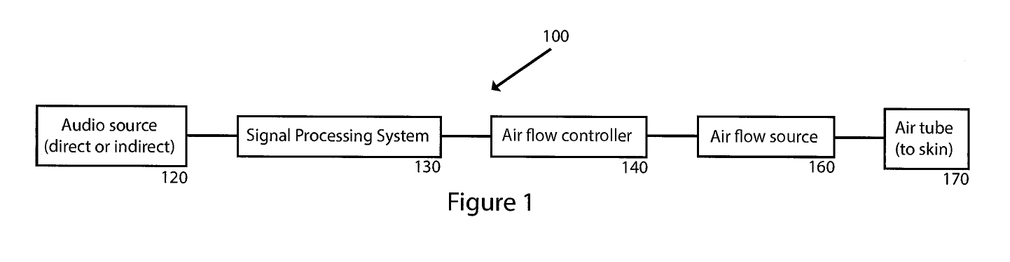

FIG. 1 shows a system 100 for enhancing perception of an acoustic signal. In particular, the system 100 is configured to enhance perception of speech information in the acoustic signal. In other embodiments, the system 100 is configured to enhance perception of aero-tactile information in the acoustic signal. The system 100 is automated and able to recover, in real-time, the turbulent air-flow that is produced during speech from the acoustic signal.

The system 100 comprises a signal processing module 130, which contains a feature extraction module for indicating and/or computing/extracting one or more salient features in an acoustic signal from an acoustic source 120, and a classification module for identifying unvoiced portions is an unvoiced acoustic portion based on the features identified by the feature extraction module. The system 100 further comprises an air-flow control module 140 for generating a control signal to a sensory stimulation actuator 160 based at least on a signal representing the unvoiced acoustic portion(s). The sensory stimulation actuator 160 is configured to generate an aero-tactile stimulation (which may be an air-flow for example), which is then output via a guide or system output 170, such as an air tube for example, to a listener's skin or any other somatosensory part of the listener.

The components and modules 120, 130, 140, and 160 of the system may be distinct and separate from each other. In some alternative embodiments, any two or all of the components and/or modules may be part of a single integrated component/module.

As used in the specification, a ‘module’ refers to a computing device or collection of machines that individually or jointly execute a set or multiple sets of instructions to perform any one or more tasks. A module also includes a processing device or collection of processing devices that are configured to perform analog processing techniques alone, or in combination with digital processing techniques. An example module comprises at least one processor, such as a central processing unit for example. The module may further include main system memory and static memory. The processor, main memory, and static memory may communicate with each other via a data bus.

Software may reside in the memory of the module and/or within the at least one processor. The memory and processor constitute machine readable medium or media. The term ‘machine readable medium’ includes any medium that is capable of storing, encoding or carrying a set of instructions for execution by the module and that cause the module to perform a task. The term machine readable medium includes solid state memories, optical media, magnetic media, non-transitory media, and carrier wave signal.

By way of example, a module may be one of, or a combination of, an analog circuit, a digital signal processing unit, an application-specific integrated circuit (ASIC), a field programmable gate array, a microprocessor, or any processing unit capable of executing computer readable instructions stored in the machine readable medium to perform a task.

The system 100 further comprises a system input 120 for receiving the acoustic signal. The system input 120 may be connectable to a microphone for receiving the acoustic signal. In other embodiments, the system input 120 may receive an acoustic signal from an acoustic recording or acoustic stream. In other embodiments, the system input 120 originates from any sensor type capable of producing, directly or indirectly, a representation of the acoustic signal.

The system 100 comprises a system output 170, such as an air tube, which is coupled to or in communication with a sensory stimulation device (not shown). The sensory stimulation device comprises an aero-tactile actuator for generating an aero-tactile stimulation that is delivered to a listener. The aero-tactile stimulation comprises air puffs or air-flow that is delivered to a listener. The aero-tactile stimulation is delivered to the listener within about 200 ms or less after the corresponding auditory portion of speech reaches the listener's ears. In some embodiments, the system 100 is configured to deliver the aero-tactile stimulation to the listener within about 100 ms after the corresponding auditory portion of speech reaches the listener's ears. In some embodiments, the system 100 is configured to deliver the aero-tactile stimulation to the listener within about 50 ms after the corresponding auditory portion of speech reaches the listener's ears.

The use of aero-tactile stimulation for speech perception has benefits over any other sensory sources of information in speech. For example, the noise in speech produced by turbulent air-flow often contains the most sensory information at high frequencies, from 4 kHz to 6 kHz, and sometimes as high or higher than 8 kHz. Conversely, direct air-flow information, through the acoustic pressure wave connected with speech generation, carries its information at very low frequencies, from below 1 Hz to 100 Hz. This low-frequency information relates to the high-frequency information caused by the turbulent flow. These high-frequency speech sounds and low-frequency pressure information are filtered out by narrowband audio codes used for phone conversation, which provide audio information from 300-3400 Hz only. Also, the signal processing in many communication devices, as well as the microphones themselves, will remove these energies, as they are omitted in transmission to conserve bandwidth, and generally not held to contain much useful information toward speech intelligibility. Aero-tactile stimulation replaces information in this high frequency sound, and is itself computationally detectable even in the lower acoustic frequencies. Alternatively, when the method is used before the application of the audio codes, a low-bandwidth signal may be obtained that can be transmitted along the coded audio so the filtered-out portions may be artificially re-introduced while still maintaining the advantage of lossy compression.

Aero-tactile stimulation is also useful for most hard-of-hearing people. High frequency audio perception is the first to diminish as a result of aging, or presbycusis. This restoration of speech information may also allow audio devices to be quieter because it enhances perception, and the listener is free to balance that out against the loudness of the conversation, and turning down audio devices helps preserve hearing. This is particularly important in any and all noise-compromised environments such as roadsides, bars, and eating establishments.

In an embodiment, the sensory stimulation device is configured to deliver the sensory stimulation to the listener in alignment with co-presented sensory stimulation such as physical taps, vibration, electrostatic pulse, optical stimuli, auditory cues, or any other sensory stimulation. In an embodiment, the auxiliary sensory stimulation(s) is/are generated using the acoustic signal, the extracted features produced by the feature extraction module, identified unvoiced portion from the classification module, or derivatives of the signal representing the candidate and/or identified unvoiced portion, such as the inverse of the turbulent air-flow signal, which contains the laminar air-flow energy.

The aero-tactile stimulation may comprise an audible enhancement of the unvoiced portions in the acoustic signal that is delivered to the listener, to enhance turbulent information in the speech signal which may be under-expressed because of the way the sound was processes, stored, or transmitted, or diminished in intelligibility due to a noise-compromised environment.

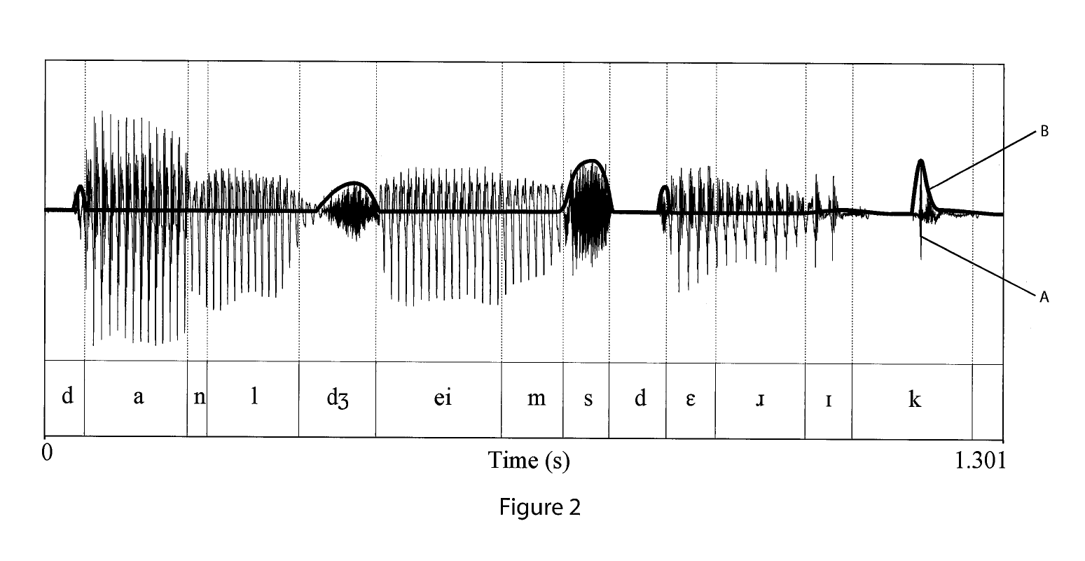

FIG. 2 shows a waveform of an acoustic signal A comprising speech information. The acoustic signal comprises turbulent air-flow information, as schematized by the solid line B. Identifying and extracting turbulent information is not a simple task because the background noise, non-turbulent (laminar) speech air-flow, and turbulent speech air-flow are all mixed together in the acoustic signal.

According to embodiments of the present invention, the acoustic signal that is received by the system input 120 uses auditory and non-auditory speech-related input with low to moderate background noise, or alternatively input from which background noise has already been filtered. Background noise comes from many sources, including steady-state turbulence (from road noise or airplane noise for example), background babble, and background transient events. There are many methods, techniques and systems that can be used to deal with this background noise. Separating turbulent non-speech acoustic information from speech for the purposes of noise reduction and noise cancellation has been an important part of audio device technology since the early 20th century.

Once the background noise in the signal has been removed or reduced, it is still difficult to convert the acoustic signal that remains to relevant air-flow information. The relationship between the acoustic signal and turbulent air-flow that leaves the mouth during speech production is highly complex. Air-flow and air pressure released from the mouth during speech are rapidly time-varying, with the highest air-flow/pressure combinations, required for tactilely detectable turbulent air-flow, occurring during transients, aspiration, and frication.

Existing methods and systems that separate voiced from unvoiced speech to segment speech are not adequate to the task of automated speech recognition. Accordingly, researchers have sought to improve such systems by separating out the energy components. Other researchers worked on deriving formulas to address the same questions simply to improve the field of digital signal processing, or to improve the process of tracking the fundamental frequency of speech (which is perceived as pitch). However, these formulas were never intended to be used to replicate air-flow from speech.

In addition, identifying air-flow from the acoustic signal requires not just extracting the portion of the turbulent information of the acoustic signal, but appropriately manipulating it based on knowledge of the transients, aspiration, and frication in speech. A big mouth opening during speech combined with sufficient laminar air-flow means that even a substantial amount of turbulent air-flow within the mouth will not translate as detectable air-flow outside the mouth. In contrast, a small mouth opening means smaller amounts of turbulent air-flow would still be detectable outside the mouth.

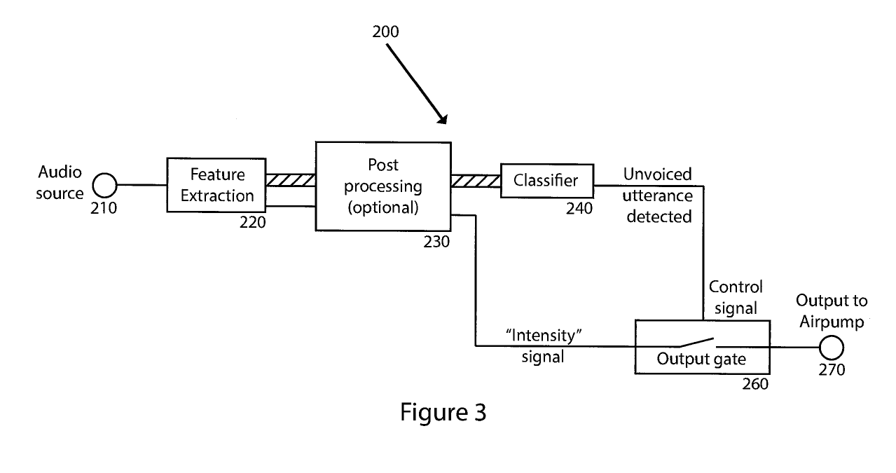

There are many possible ways to implement the signal processing components shown in FIG. 1 required to detect the unvoiced portions of speech and operate the sensory stimulation device in a suitable manner. FIG. 3 shows a system 200 according to a second embodiment of the invention, which is an extension of the system 100 shown in FIG. 1. Features described with reference to FIG. 3 have similar or identical functionality as corresponding features described with reference to FIG. 1 indicated by like reference numerals with the addition of 100.

It should also be noted that some embodiments of the processing system use one or more sensor devices that capture different aspects of the acoustic signal, some of which are not traditionally related to audio capture. Use of such devices changes or complements the feature extraction module. In addition to traditional microphones, pressure transducers, force meters, flow meters based on thermal, optical, force, vortex shedding, and others, imaging-based methods and any other method capable of capturing acoustic information are envisaged.

Specifically, the use of very low-frequency capable (below 100 Hz) sensors is of use to capture aspects of turbulent flow, especially plosives, directly. These are difficult to obtain from the audio signal in a purely computational manner. Combined use of direct measurement estimates and computational estimates, can further increase the system performance.

The system 200 comprises a feature extraction module 220 for receiving an acoustic signal from an acoustic source 210. The feature extraction module 220 is configured to process the acoustic information to extract one or more identifying features that, alone or combined, when interpreted through some means, indicate the candidate or possible unvoiced portions of the signal. Examples of such features are, but are not limited to: perdiodicity, autocorrelation, zero-crossing rate, instantaneous frequency, frequency-energy (such as Teager's energy), rate of change, intensity, RMS value, time-spectral information (such as wavelets, short-time fast Fourier transformations), filter banks, various demodulation schemes (amplitude modulation, frequency modulation, phase modulation, etc), statistical measures (median, variance, histograms, average values, etc), the input signal itself, and combinations thereof.

As these extracted features are often noisy or exhibit a response that may result in better performance where it is enhanced in some way, the system 200 comprises a post-extraction processing module 230 for post-processing of the output of the feature extraction module 220. In some embodiments, the system may not comprise the post-extraction processing module. In those embodiments, the outputs from the feature extraction module 220 are used directly by the classification module and/or the control module 260. The operations performed by the post-extraction processing module 230 include one or more of: filtering (high pass, low pass, band pass, moving-averages, median filtering, etc), linear and non-linear mappings (ratios of signals, scaling, logarithms, exponentials, powers, roots, look-up tables, etc), gating operations, range limiting, normalization, and combinations thereof for example.

The system comprises a classification module 240 for processing the features from the post-extraction processing module 230. This module 240 interprets the features, and/or the signal itself, to perform the actual identification of the unvoiced passages. The classification module 240 may be configured to implement a wide variety of methods known to the art, such as, but not limited to: heuristics (state machines), statistical approaches (Bayesian, Markov models & chains, etc), fuzzy logic, learning systems (neural networks, simulated annealing, linear basis functions, etc), pattern matching (database, look-up tables, convolution, etc), and more.

Embodiments of the system 200 may comprise a post-classification processing module (not shown) for processing the output signal from the classification module 240. The post-classification module may be configured to carry out operations similar to those described above for the post-extraction processing module 230.

Finally, the system 200 comprises a control module 260 for receiving the classifier output signal, which identifies the unvoiced passages, from the classification module 240. The control module 260 uses this signal either directly, or indirectly to obtain the control signal for the aero-tactile actuator that is connected to the output port 270. Where the control module uses the signal indirectly, the classifier output signal, or a suitable feature/characteristic of the signal (such as intensity, envelope, etc) is gated/controlled in a linear or non-linear fashion by the classifier output.

Embodiments of the system 200 may comprise a post-control processing module (not shown) for processing the control signal output before the signal is delivered to the aero-tactile actuator. The post-control module may be configured to carry out operations similar as those describe above for the post-extraction processing module.

Additionally, some wave and/or spectral shaping may be required to match the actuator response, outliers may have to be removed, and other typical processing one skilled in the art would apply to optimally match the actuator response to the desired response.

Implementations of the system 200 will be described below by way of non-limiting example.

### Example 1: Zero-Crossing Rate Technique

Hissing-type utterances (unvoiced) exhibit a wide spectrum. On the other hand, utterances with a strong fundamental and associated harmonics exhibit a much more periodical appearances and therefore a spectrum with more clearly identifiable peaks. Although a periodicity computation could be used to identify voiced utterances from unvoiced utterances, this computation is very computationally intensive and exhibits limited performance for the computational cost involved.

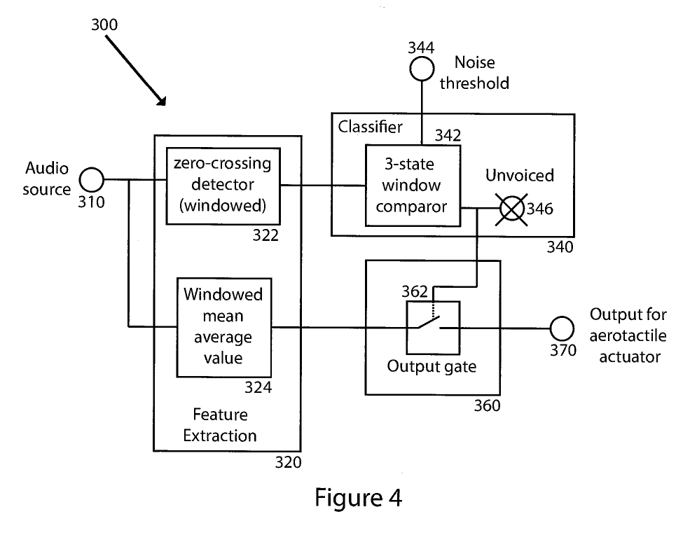

FIG. 4 shows a system 300 for generating a control signal to an aero-tactile device. Unless otherwise described, features described with reference to FIG. 4 have similar or identical functionality as corresponding features described with reference to FIG. 3 indicated by like reference numerals with the addition of 100.

The system 300 implements a simple approach with usable performance under controlled conditions, by measuring the number of zero crossings of the input acoustic signal per time unit. This zero-crossing rate is computable with a low computational complexity and could be readily delegated to hardware.

A system based on the zero-crossing rate works because of the nature of voiced and unvoiced utterances. Using a suitable tuned threshold on the zero-crossing rate to prevent the method from triggering on noise, it is clear upon inspection of the involved waveforms that the voiced utterances ‘lift’ the high frequency aspects of the signal away from the average value of the signal. Thus, these high-frequency aspects do not produce zero-crossings during a large portion of the period of the voiced fundamental, resulting in a relative low zero-crossing rate. The threshold is determined experimentally, or through an adaptive algorithm, and is set below the zero-crossing rate measured during passages where no speech is present (low signal magnitude, high zero-crossing rate), but where the environmental noise and other factors are present. The threshold must also be above the rate for unvoiced segments (signal magnitude above the noise floor, high zero-crossing rate), so the voiced sections (high signal magnitude, relatively low zero-crossing rate) are ignored.

The system 300 comprises a feature extraction module 320 for indicating candidate unvoiced utterances from an acoustic signal received from an acoustic source 310. The feature extraction module comprises a zero-crossing detector 322 for determining the number of zero crossings of an acoustic signal over a duration. The zero-crossing rate number from the zero-crossing detector 322 is an output of the feature extraction module 320.

The feature extraction module additionally comprises a windowed mean average value 324 for calculating an intensity of the same portion of the acoustic signal that is processed by the zero-crossing detector, where the intensity signal is delivered to the control module 362.

The zero-crossing rate from the feature extraction module 320 is used in a comparator 342 of a classification module 340. The comparator 342 may be a 3-state window comparator for distinguishing between noise, unvoiced utterances, and voiced utterances. Unvoiced utterances are characterised by a high rate of zero-crossings per unit of time (as they appear very noise-like upon inspection) compared to the rate encountered during voiced utterances, resulting in a much higher zero-crossing rate compared to the voiced utterances. By using suitable set thresholds 344, determined so the comparator 342 classifies the signal successfully, and post-processing of this rate signal, three bands may be identified: noise, unvoiced utterances, and voiced utterances. In the preferred implementation of the present invention, only the unvoiced threshold was implemented to produce a signal representing the unvoiced portions 346 in the acoustic signal, as the other two bands both signify portions of the signal of no interest.

The system 300 comprises a control module 360. The classification module has a gate 362 that receives the signal representing the unvoiced portions 346 from the classification module 340, and the intensity signal calculated by the windowed mean average value 324 of the feature extraction module 320. The gate 362 generates an output control signal to the output port 370 that is configured to be connected or in communication with an aero-tactile actuator. In this particular implementation, the windowed mean average value of the input signal from the feature extraction module 320 is gated by the gate 362 using the signal 346 from the classification block to generate the output control signal.

The disadvantage of the zero-crossing technique is in setting the (dynamic) threshold values (with or without hysteresis action) in a manner that will reliably differentiate between background noise and adapt reliably to the speaker and the environment conditions.

The advantage of the zero-crossing technique is great simplicity and ability to be implemented even as an analogue system with low complexity. The (adaptive) threshold could be computed using a system that has no need to process the acoustic signal in real-time, further reducing implementation cost.

### Example 2: Teager's Energy/Discrete Energy Separation Technique

As the zero-crossing rate method showed much room for improvement, a better method was sought while still keeping in mind the need to operate on limited hardware.

Just as the zero-crossing method was based on a physical aspect of the signal, the method using Teager's energy and discrete energy separation takes this reasoning one step further and seeks to use knowledge of the processes by which speech is generated.

It is a fact of physics that, to generate two signals of equal amplitude, it takes more energy to generate a high-frequency signal than a low-frequency one. Unvoiced utterances are basically wide-band noise (although more correlated than noise), meaning that much energy went into their creation. In voiced utterances, most energy is bundled in a, comparatively, low-frequency fundamental. Thus, a method that assigns a different energy to each frequency band based upon the physical processes by which the frequencies are generated would give a useful indication to differentiate between voiced and unvoiced utterances. One such possible method is Teager's energy. This method recognizes that, given two signals of the same amplitude but different frequency, that the lower-frequency one would have taken less energy to produce, and thus assigns this lower-frequency signal a lower energy reading than the higher-frequency signal of the same amplitude. As a voiced utterance contains mainly lower-frequency components, with most of the energy bundled around the fundamental and a number of harmonics, such a signal will result in a lower Teager's energy reading than an unvoiced signal of equal amplitude, where most of the energy is spread in the higher frequency components. This algorithm, although noise sensitive, has the great advantage of being able to operate on a per-sample basis, and requires little computation to implement.

An extension to this method is the family of discrete energy separation algorithms (DESA). These algorithms are best understood in terms of traditional demodulation theory. DESA provides the instantaneous frequency (relating to frequency modulation) and magnitude (relating to amplitude modulation). It is this instantaneous frequency that is of interest here as the main feature, combined with the zero-crossing rate which also yields much information.

### Example 3: Combination of Zero-Crossing Rate, Teager's Energy, and Discrete Energy Separation Techniques

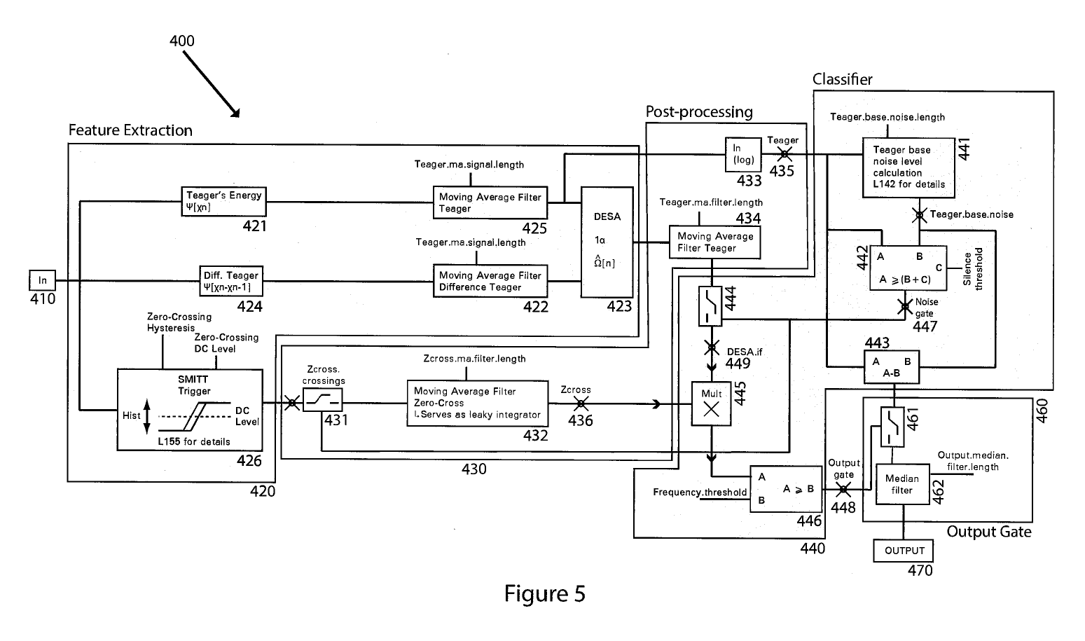

FIG. 5 shows a system 400 that combines the zero-crossing rate and Teager's energy techniques described above to improve the overall performance. Unless otherwise described, features described with reference to FIG. 5 have similar or identical functionality as corresponding features with reference to FIG. 3 indicated by like reference numerals with the addition of 200.

The functional blocks of the system 400 have many interactions with each other. The system 400 primarily adopts a heuristic approach, with signals from the classification module 440 being used as feedback signals to the feature extraction post-processing module 430 to be used as noise gating functions to improve the algorithm's performance.

The system 400 comprises a feature extraction module 420 for obtaining signal features relevant to indicating candidate unvoiced portions in the acoustic signal received from an acoustic source 410, a classification module 440 for determining if a candidate unvoiced portion is an unvoiced portion from the obtained signal features, and a control module 460 for generating a control signal for an aero-tactile actuator.

The system 400 additionally comprises a post-extraction processing module 430 for processing the signals from the feature extraction module 420 and for communicating the processed signals to the classification module 440. The system 400 further comprises components for a post-classification processing module that is included in the classification module 440. The heuristic classification directly interacts with the post-processing of the features.

In the feature extraction module 420, the system 400 comprises a Teager's energy computation block 421 for calculating frequency energy of a sample of the acoustic signal. The feature extraction module 420 additionally comprises a differential Teager's energy computation block 424 for computing the energy difference between the current sample and the previous sample. The calculated energy values from the Teager's energy and differential Teager's energy computation blocks 421, 424 are filtered using a respective filter 425, 422. The filters 425, 422 may be moving average filters. The filtered values are processed by the DESA block 423, which provides the instantaneous frequency. The DESA block 423 is also part of the feature extraction module 420. The feature extraction module 420 further comprises a zero-crossing detector block 426 for determining zero-crossings of the acoustic signal.

The moving average filters 422, 425 before the DESA algorithm of block 423 are important, as Teager's energy calculations use differential operators, making the method sensitive to noise. Filtering helps reduce this sensitivity.

The post-extraction processing module 430 comprises a scaling component 433 to accentuate smaller contributions in the Teager's energy in the signal from the filter 422. These contributions contain useful information that otherwise is easily lost, while very strong signals can be reduced without much penalty. The scaling component 433 may use a natural logarithm algorithm to scale the Teager's energy accordingly for example. The post-extraction processing module 430 additionally comprises an instantaneous frequency filter 434 for filtering the output of the DESA 423. The post-extraction processing module 430 further comprises a zero-crossing gate 431 and a zero-crossing filter 432 for processing the zero-crossings signal from the zero-crossing detector block 426. The zero-crossing gate 431 is applied before the zero-crossing filter 432 to remove zero crossings identified as noise from showing in the output. The zero-crossing filter 432 may be a moving average filter.

In the classification module 440, a computation block 441 and a first decision block 442 compute a noise threshold control signal. Using the dynamic range compressed version of Teager's energy from the scaling component 433, a configurable threshold (silence threshold) implements the noise gating. Computation block 441 is configured to compute an average of the signal, which is used in the first decision block 442 to produce a threshold gating signal 447 for both the zero-crossing signal in the zero-crossing gate 431 and the filtered instantaneous frequency from the instantaneous frequency filter 434 in an instantaneous frequency control gate 444.

The classification module 440 comprises a multiplier 445 for multiplying the signal 449 from the instantaneous frequency control gate 444 and the signal 436 from the zero-crossing filter 432. It was found, experimentally, that the control signal obtained by multiplying the filtered instantaneous frequency and the filtered zero-crossing rate produced a better performing output gating signal compared to using either signal by itself. The multiplication enhances those portions of the features where they both agree there is an unvoiced contribution, but also prevents spurious contributions when one of both input signals is zero. The classification module 440 comprises a second decision block 446 for determining if the signal is an unvoiced signal. When this control signal exceeds a threshold (frequency threshold), the features are considered strong enough to be an unvoiced section in the input signal. The classification module 440 additionally comprises a subtraction block 443 for determining a Teager's energy without the noise component that was calculated in computation block 441. The signal from the subtraction block 443 is the compressed Teager's energy from scaling block 433, minus the average value (DC level is related to background noise) calculated by computation block 441.

This output gate signal 448 is now used to gate a suitably processed feature, or combination of features, to the output to actuate the sensory stimulation actuator.

The control module 460 comprises a gate 461 that is configured to output the Teager's energy without the noise component from the subtraction block 443 gated according to the control signal from the second decision block 446. The control module 460 additionally comprises a filter 462 to remove brief, spurious responses from the resulting output of the gate 461. The output of the classification block is communicated to an output port 470 that is configured to be connected or in communication with a sensory stimulation actuator.

The sensory stimulation actuator is configured to deliver the sensory stimulation onto the listener's skin. In an embodiment, the sensory stimulation actuator is configured to deliver the stimulation to any tactile cell of the listener. In an embodiment, the sensory stimulation actuator is configured to deliver the stimulation onto the listener's ankle, ear, face, hair, eye, nostril, or any other part of the listener's body. In an embodiment, the system is part of or in communication with a hand-held audio device, and the sensory stimulation device is configured to provide the stimulation to the hand. In an embodiment, the system is part of or in communication with a head-held or mounted audio device, and the sensory stimulation device is configured to provide the stimulation to the head.

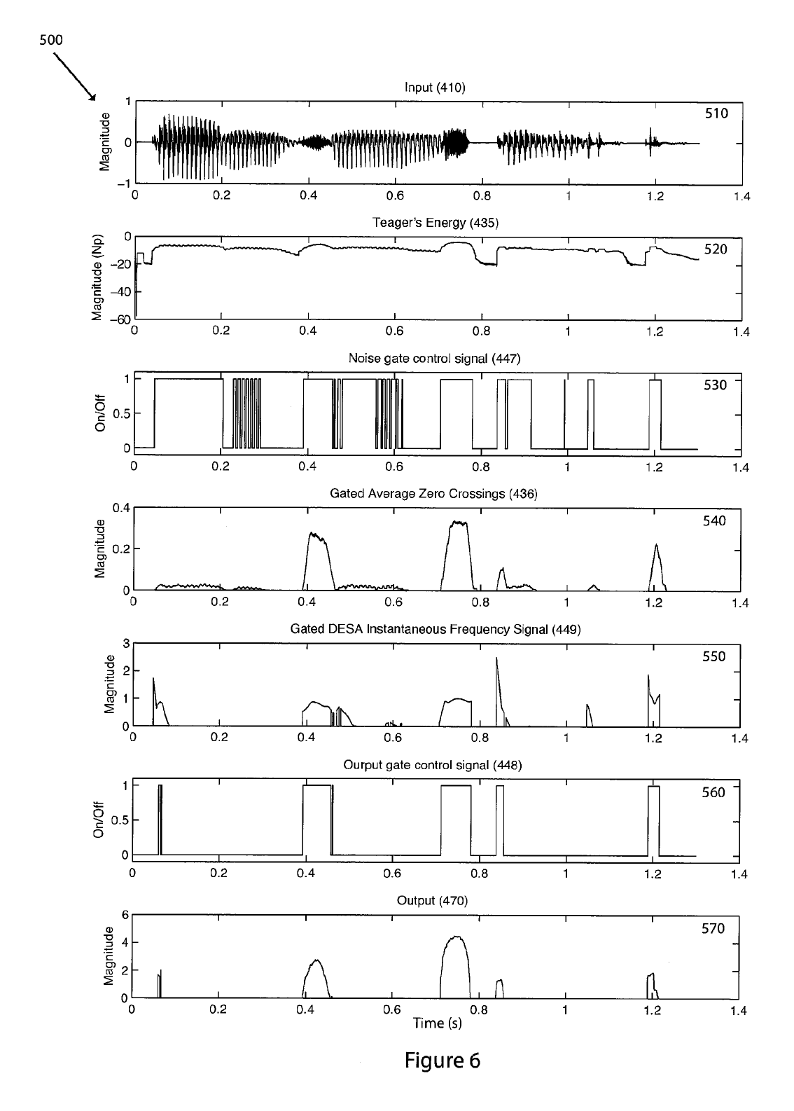

FIG. 6 shows waveforms 500 of an example processed signal at different stages of operation of the system 400 illustrated in FIG. 5 and described in Example 3. The first waveform 510 is the input waveform received from the acoustic source 410. The second waveform 520 corresponds to Teager's energy 435 from the scaling component 433. The third waveform 530 corresponds to the noise gate control 447 from the first decision block 442. The fourth waveform 540 corresponds to the gated average zero crossings 436 from the zero-crossing filter 432. The fifth waveform 550 corresponds to the Gated DESA Instantaneous Frequency Signal 449 from the frequency control gate 444. The sixth waveform 560 corresponds to the Output gate control signal 448 from the second decision block 446. The seventh waveform 570 corresponds to the output 470 of the system 400.

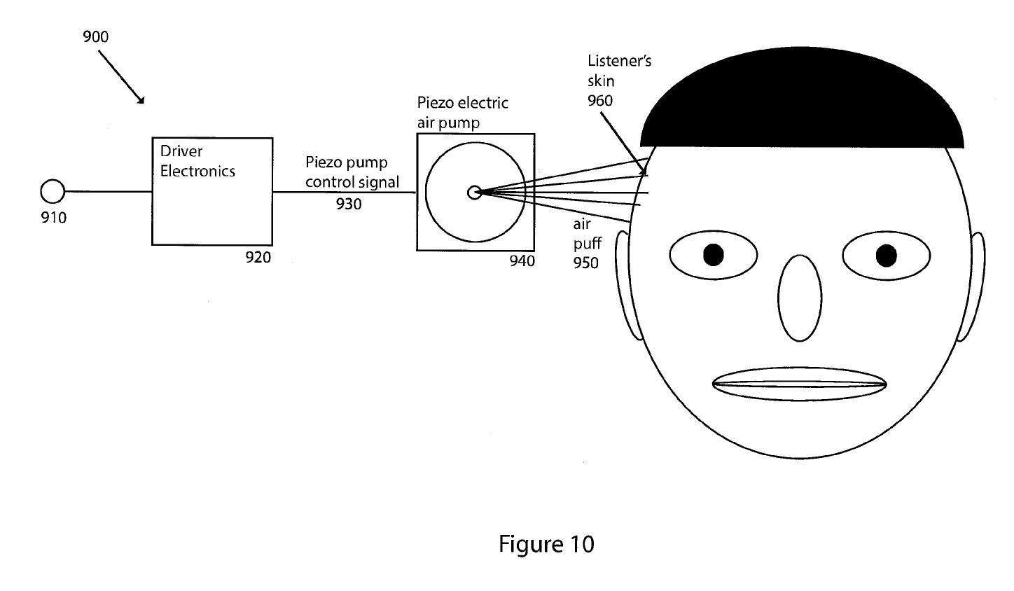

FIG. 10 demonstrates a sensory actuator 900 based on an air-puff 950 generated by a piezo-electric pump 940. The actuator 900 receives a control signal 910 that represents the desired aero-tactile stimulation to be delivered to the user's skin 960 or any other somatosensory part of the user. The system 900 comprises driver electronics 920 for using the control signal 910. The driver electronics 920 amplifies this control signal 910 and converts the signal into a suitable electric signal 930 for driving the piezo-electric pump 940. This pump 940 produces air puffs 950 that are directed, either directly or through a guide or an air conduit, such as a tube, to a somatosensory body part of the user, such as the user's skin 960 for example.

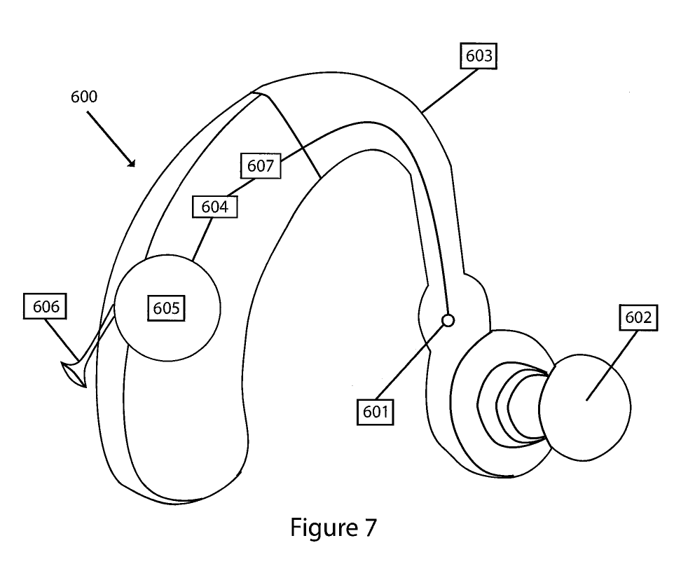

FIG. 7 demonstrates how the aero-tactile speech perception enhancement system 604 might integrate into a behind-the-ear hearing-aid 600. The hearing-aid comprises an ear-piece 602 for hearing-aid amplification and an arm 603 for mounting the hearing aid behind the listeners ear. Where the aero-tactile stimulation comprises audible stimulation, the audible stimulation can be delivered through the ear piece 602. The system shown may take auditory input from either a microphone 601 and digitizer 607, or from an external source. Pre-processing to remove noise and extreme transients, provide focus on one speaker, or any other signal post-processing may come from systems external to the system as part of the hearing-aid 600. This cleaned signal will then be subjected to the signal processing required to convert the acoustic signal to an aero-tactile stimulation signal, as described above. The aero-tactile stimulation signal is then passed to a controller of an air-flow source 605, which is configured to output a puff of air to the listener's skin, through an air tube 606, behind the ear synchronous to the hearing aid passing amplified audio to the ears.

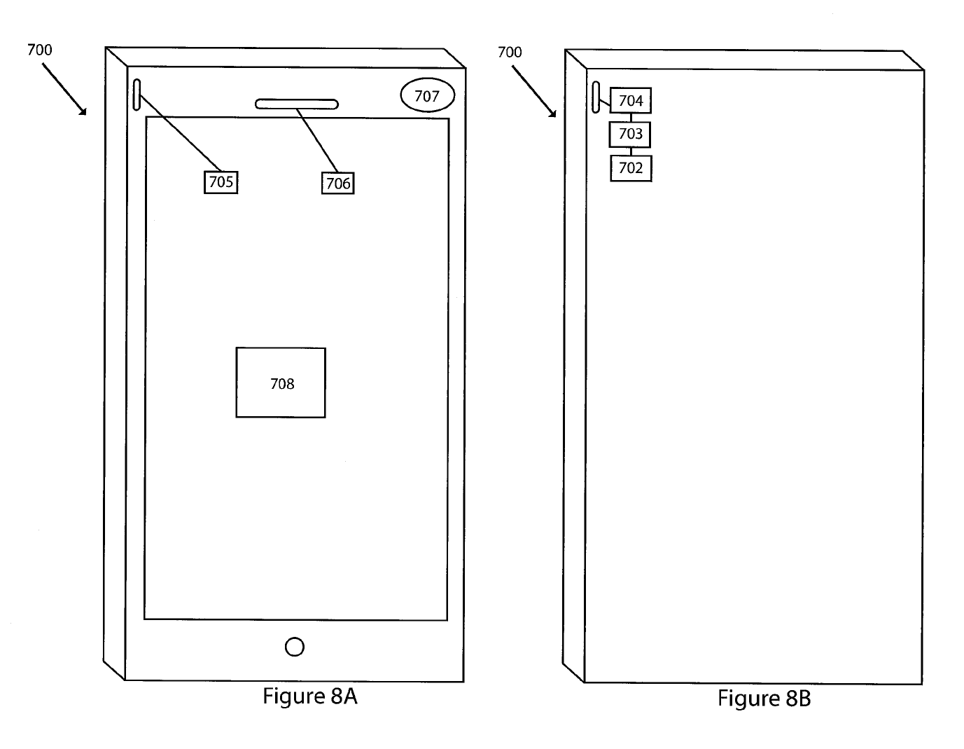

FIGS. 8A and 8B demonstrate how the aero-tactile speech perception enhancement system might integrate into a smart device 700. FIG. 8A shows the smart device 700 from the front, while FIG. 8B shows the smart device 700 from the back. The system shown is configured to receive an auditory input 702 from a digital source such as a GSM signal. Like the hearing-aid, pre-processing to remove noise, extreme transients, or any other signal post-processing may come from the smartphone systems. This cleaned signal will then be subjected to the signal processing required to convert the acoustic signal to an air-flow signal, by the system 703 of the present invention as described above. The air-flow signal is then passed to the air-flow controller and air-flow source 704, and air is passed to the skin (typically on the hand or behind the ear), through the air tube 705, that is synchronous to the smartphone passing amplified acoustic to the ears through the speaker 706.

In some embodiments of the smart device, the smart device comprises an optical actuator that is configured to output an optical stimulation based on the aero-tactile stimulation signal. In an embodiment, the optical actuator comprises a light source 707 in the smart device 700. In an embodiment, the optical stimulation comprises a change in brightness in a backlight display 708 of the smart device or any other electronic device. In some embodiments of the smart device, the aero-tactile stimulation includes audible sensory stimulation.

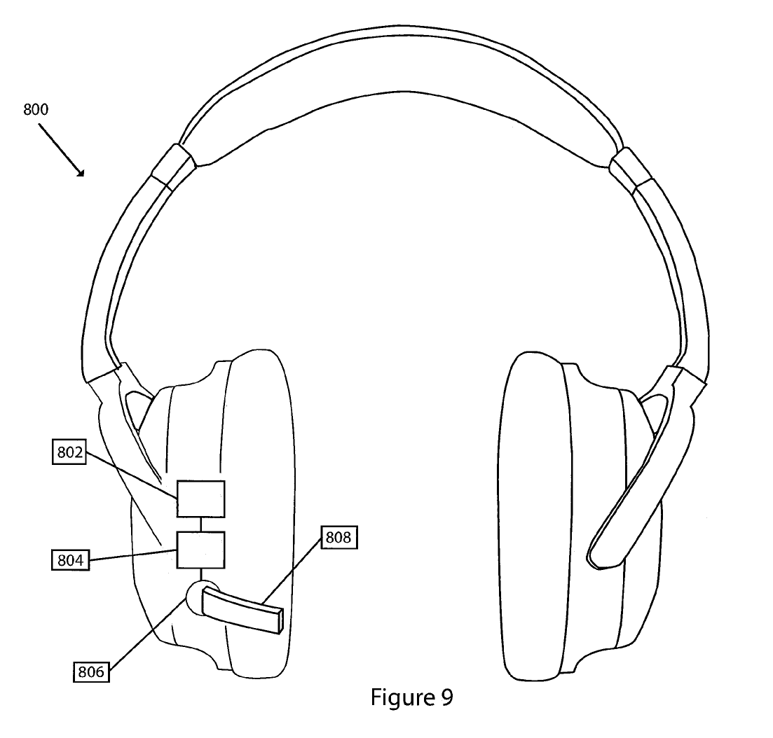

FIG. 9 demonstrates how the aero-tactile speech perception enhancement system might integrate into a set of headphones 800. The system shown will take auditory input 802 from a digital source such as a headphone jack or wireless transmission. Like the hearing-aid, pre-processing to remove noise, extreme transients, or any other signal post-processing may come from the headphone systems. This cleaned signal will then be subjected to the signal processing required to convert the acoustic signal to an air-flow signal, by the system 804 of the present invention as described above. The air-flow signal is then passed to the air-flow controller and air-flow source 806, and air is passed, through the air tube 808, to the skin behind the ear synchronous to the headphones passing amplified acoustic to the ears.

In some embodiments of the headphones, the aero-tactile stimulation includes audible sensory stimulation.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

1. An audio perception system, the system comprising:
a capture module configured to capture acoustic speech signal information;
a feature extraction module configured to extract features that identify a candidate unvoiced portion in an acoustic signal;
a classification module configured to identify if the acoustic signal is or contains an unvoiced portion based on the extracted features; and
a control module configured to generate a control signal to a sensory stimulation actuator for generating an aero-tactile stimulation to be delivered to a listener, the control signal based at least in part on a signal representing the identified unvoiced portion.

2. The system of claim 1 wherein the capture module is connected to a sensor configured to generate the acoustic speech signal information.

3. The system of claim 2 wherein the sensor comprises an acoustic microphone.

4. The system of claim 1 wherein the capture module is connected to a communication medium adapted to generate the acoustic speech signal information.

5. The system of claim 1 wherein the capture module is connected to a computer-readable medium on which is stored the acoustic speech signal information.

6. The system of claim 1 wherein the capture module comprises a pressure transducer.

7. The system of claim 1 wherein the capture module comprises a force sensing device placed in or near the air-flow from the lips of a human speaker.

8. The system of claim 1 wherein the capture module comprises an optical flow meter.

9. The system of claim 1 wherein the capture module comprises a thermal flow meter.

10. The system of claim 1 wherein the capture module comprises a mechanical flow meter.

11. The system of claim 1 wherein the capture module is configured to capture acoustic speech signal information including information from turbulent flow and/or a speech pressure wave generating turbulent flow.

12. The system of claim 1 wherein the feature extraction module is configured to identify salient aspects of the signal that, when interpreted by the classification module, are used to identify unvoiced portions based on one or more of the extracted features of the acoustic signal.

13. The system of claim 1 wherein the feature extraction module is configured to extract features relevant to unvoiced portions based on one or more of a zero-crossing rate, a periodicity, an autocorrelation, an instantaneous frequency, a frequency energy, a statistical measure, a rate of change, an intensity root mean square value, time-spectral information, a filter bank, a demodulation scheme, or the acoustic signal itself.

14. The system of claim 1 wherein the feature extraction module is configured to compute the zero-crossing rate of the acoustic signal, the classification module using said zero crossing rate to indicate that a portion of the acoustic signal is an unvoiced portion if at least one of zero-crossings per unit of time of the portion of the acoustic signal is above a threshold.

15. The system of claim 1 wherein the feature extraction module is configured to compute a frequency energy of the acoustic signal, the classification module indicating that a portion of the acoustic signal is an unvoiced portion if the frequency energy of the portion of the acoustic signal is above a threshold.

16. The system of claim 15 wherein the feature extraction module is configured to calculate the frequency energy based on Teager's energy.

17. The system of claim 1 wherein the feature extraction module is configured to compute a zero-crossing and frequency energy of the acoustic signal that, when combined, is used by the classification module to identify if the acoustic signal is or contains the unvoiced portion.

18. The system of claim 1 wherein the feature extraction module is configured to use a low frequency acoustic signal from a sensor to identify the candidate unvoiced portion in an acoustic signal.

19. The system of claim 1 wherein the classification module is configured to identify the unvoiced portion based on one or more of heuristics, logic systems, mathematical analysis, statistical analysis, learning systems, gating operation, range limitation, and normalization on the candidate unvoiced portion.

20. The system of claim 1 wherein the control module is configured to generate the control signal based on a signal representing the candidate unvoiced portion in the acoustic signal.

21. The system of claim 20 wherein the control module is configured to convert the signal representing the unvoiced portion into a signal representing turbulent air-flow based on energy in the turbulent air-flow information of the unvoiced portion, transformed based upon the relationship between this energy and likely air-flow from speech.

22. The system of claim 21 wherein the signal representing turbulent air-flow is an envelope of the acoustic signal representing turbulent air-flow information.

23. The system of claim 21 wherein the signal representing turbulent air-flow is a differential of the signal representing the unvoiced portion.

24. The system claim 21 wherein the signal representing turbulent air-flow is an arbitrary signal having at least one signal characteristic, where the at least one signal characteristic indicates an occurrence of turbulent information in the acoustic signal.

25. The system of claim 24 wherein the arbitrary signal comprises an impulse train where a timing of each impulse indicates the occurrence of turbulent information.

26. The system of claim 24 wherein the signal characteristic comprises one or more of a peak, a zero-crossing, and a trough.

27. The system of claim 1 further comprising at least one post-processing module.

28. The system of claim 27 wherein the at least one post-processing module is configured to filter, use linear or non-linear mapping, use gating operations, use range limitations, and/or normalization to enhance a signal to the at least one post-processing module.

29. The system of claim 28 wherein the at least one post-processing module is configured to filter the signal using one or more of high pass filtering, low pass filtering, band pass filtering, band stop filtering, moving averages and median filtering.

30. The system of claim 27 wherein the at least one post-processing module comprises a post-feature extraction processing module for processing a signal representing the extracted features for the candidate unvoiced portion for the classification module, the classification module configured to identify the unvoiced portion based on an output from the post-feature extraction processing module.

31. The system of claim 27 wherein the at least one post-processing module comprises a post-classification module for processing the signal representing the unvoiced portion from the classification module, the control module configured to generate the control signal based on an output from the post-classification processing module.

32. The system of claim 27 wherein the at least one post-processing module comprises a post-control processing module for processing the control signal from the control unit, the sensory stimulation actuator configured to output an aero-tactile stimulation based on an output from the post-control processing module.

33. The system of claim 27 wherein the at least one post-processing module comprises a post-control processing module for processing the control signal from the control unit.

34. The system of claim 33 wherein the sensory stimulation actuator comprises an optical actuator that is configured to output an optical stimulation based on an output from the post-control processing module.

35. The system of claim 34 wherein the optical actuator comprises a light source in an electronic device of the listener.

36. The system of claim 34 wherein the optical stimulation comprises a change in brightness in a backlight display of the electronic device.

37. The system of claim 33 wherein the sensory stimulation actuator comprises a somatosensory actuator that is configured to output a stimulation based on an output from the post-control processing module.

38. The system of claim 33 wherein the sensory stimulation actuator comprises a sound actuator that is configured to output an audible stimulation based on an output from the post-control processing module.

39. The system of claim 38 wherein the sound actuator comprises an acoustic sub-system of a host device, and/or a loud speaker.

40. The system of claim 1 wherein the acoustic signal comprises a speech signal.

41. The system of claim 1 wherein the acoustic signal comprises any information caused from turbulent vocal tract air-flow.

42. The system of claim 1 wherein the acoustic signal comprises any information caused from artificial turbulent vocal tract air-flow.

43. The system of claim 42 wherein the acoustic signal comprises speech, acoustic information, and/or audio produced by a speech synthesis system.

44. The system of claim 1 further comprising a receiver for receiving the acoustic signal.

45. The system of claim 44 wherein the receiver is configured to receive the acoustic signal from a sensor device.

46. The system of claim 45 wherein the sensor comprises an acoustic microphone device.

47. The system of claim 46 wherein the microphone device comprises a microphone digitizer for converting the acoustic signal from a microphone to a digital signal.

48. The system of claim 44 wherein the receiver is configured to receive the acoustic signal from an external acoustic source.

49. The system of claim 48 wherein the receiver is configured to receive the acoustic signal in one of real-time or pre-recorded.

50. The system of claim 1 further comprising a post-receiver processing module for removing undesired background noise and undesired non-speech sound from the acoustic signal.

51. The system of claim 1 wherein the capture module is configured to capture acoustic speech signal information from a pre-filtered speech acoustic signal.

52. The system of claim 1 wherein the capture module is configured to capture acoustic speech signal information from clean acoustic signals not requiring filtering.

53. The system of claim 1 claims further comprising a sensory stimulation actuator for generating the aero-tactile stimulation.

54. The system of claim 53 wherein the sensory stimulation actuator is configured to generate the aero-tactile stimulation based at least partly on the control signal directly from the control module and/or indirectly from the control module via a post-control processing module.

55. The system of claim 53 wherein the sensory stimulation actuator is configured to generate the aero-tactile stimulation based at least partly on the unvoiced portion directly from the classification module and/or indirectly from the classification module via a post-classification processing module.

56. The system of 55 claim 53 wherein the sensory stimulation actuator comprises an aero-tactile actuator.

57. The system of claim 56 wherein the aero-tactile stimulation comprises one or more air puffs and/or air-flow.

58. The system of claim 53 55 wherein the sensory stimulation actuator comprises a vibro-tactile actuator.

59. The system of claim 58 wherein the vibro-tactile actuator is configured to generate a vibro-tactile stimulation based on a voiced portion in the acoustic signal.

60. The system of claim 53 55 wherein the aero-tactile stimulation comprises direct tactile stimulation for simulating somatosensory senses of the listener.

61. The system of claim 53 55 wherein the sensory stimulation actuator comprises an electro-tactile actuator, the aero-tactile stimulation comprising an electrical stimulation for simulating somatosensory senses of a listener.

62. The system of claim 53 55 wherein the sensory stimulation actuator comprises an optical actuator, the aero-tactile stimulation comprising optical stimuli.

63. The system of claim 53 55 wherein the sensory stimulation actuator comprises an acoustic actuator, the aero-tactile stimulation comprising auditory stimuli.

64. The system of claim 53 63 wherein the sensory stimulation actuator is configured to deliver two or more different aero-tactile stimulations to the listener.

65. The system of claim 64 wherein the two or more different aero-tactile stimulations comprise two or more of physical taps, vibration, electrostatic pulses, optical stimuli, auditory stimuli, and other sensory stimulation.

66. The system of claim 64 wherein the aero-tactile stimulations are generated using the acoustic signal, the features extracted from the acoustic signal by the feature extraction module, the identified unvoiced portion from the classification module, or derivatives of the signal representing the candidate and/or identified unvoiced portion which contains the turbulent air-flow energy.

67. The system of claim 66 wherein the identified unvoiced portion comprises the inverse of the turbulent air-flow signal.

68. The system of claim 1 wherein the sensory stimulation actuator is configured to deliver the aero-tactile stimulation on to the listener's skin.

69. The system of claim 1 wherein the sensory stimulation actuator is configured to deliver the stimulation to any tactile cell of the listener.

70. A method for acoustic perception, the method comprising:
capturing, by a capture module, acoustic speech signal information;
determining, by a feature extraction module, features that identify a candidate unvoiced portion in an acoustic signal;
determining, by a classification module, if the acoustic signal is or contains an unvoiced portion based on the extracted features; and
generating, by a control module, a control signal to an actuator for generating an aero-tactile stimulation to be delivered to a listener, the control signal based at least in part on a signal representing the unvoiced portion.

71. The method of claim 70 further comprising delivering, by a sensory stimulation actuator, the aero-tactile stimulation to a listener, wherein the aero-tactile stimulation is generated based on the stimuli from the actuator.

72. The method of claim 71 wherein the sensory stimulation actuator comprises one or more actuators that is/are configured to deliver the aero-tactile stimulation information to the listener, in the form of tactile stimulation, optical/visual stimulation, auditory stimulation, and/or any other type of stimulation.
